(19) United States
(12) Patent Application Publication
(10) Pub. No.: US 2026/0247334 A1
(43) Pub. Date: Aug. 20, 2026

(54) TRANSMISSION AND RECEPTION OF SIDELINK POSITIONING REFERENCE SIGNAL

(71) Applicant: Panasonic Intellectual Property Corporation of America, Torrance, CA (US)

(72) Inventors: Yang KANG, Singapore (SG); Hidetoshi SUZUKI, Kanagawa (JP); Xuan Tuong TRAN, Singapore (SG); Hong Cheng Michael SIM, Singapore (SG)

(73) Assignee: Panasonic Intellectual Property Corporation of America, Torrance, CA (US)

(21) Appl. No.: 19/471,958

(22) PCT Filed: Feb. 19, 2024
(86) PCT No.: PCT/SG2024/050085

§ 371 Date: Oct. 2, 2025

(30) Foreign Application Priority Data
Apr. 6, 2023 (SG) 10202300958Y

(51) Int. Cl. H04W 64/00; H04W 72/25; H04W 76/40

(52) U.S. Cl. CPC H04W 64/00; H04W 72/25; H04W 76/40

(57) ABSTRACT

The present disclosure provides communication apparatuses and communication methods for transmission and reception of Sidelink Positioning Reference Signal (SL-PRS). The communication apparatuses include a communication apparatus comprising: circuitry, which in operation, generates a SL-PRS; and a transmitter, which in operation, transmits the SL-PRS based on a signaling.

### TECHNICAL FIELD

The present disclosure relates to communication apparatuses and communication methods for transmission and reception of sidelink positioning reference signal (SL-PRS).

### BACKGROUND

Sidelink (SL) positioning has been specified in 3GPP Release 18 Expanded and Improved New Radio (NR) Positioning, as described in WID RP-223549. A work item relating to sidelink positioning is newly introduced into 3GPP in release 18 to support sidelink ranging and positioning with sidelink positioning reference signal (SL-PRS).

However, there has still been no discussion on how transmission and reception of SL-PRS can be implemented.

There is thus a need for communication apparatuses and methods that provide feasible technical solutions for transmission and reception of SL-PRS. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and methods for transmission and reception of SL-PRS.

According to a first embodiment of the present disclosure, there is provided a communication apparatus comprising: circuitry, which in operation, generates a sidelink positioning reference signal (SL-PRS); and a transmitter, which in operation, transmits the SL-PRS based on a signaling.

According to a second embodiment of the present disclosure, there is provided a communication apparatus comprising: a receiver, which in operation, receives a sidelink positioning reference signal (SL-PRS) based on a signaling; and; circuitry, which in operation, decodes the SL-PRS.

According to a third embodiment of the present disclosure, there is provided a first communication apparatus comprising: circuitry, which in operation, generates a signaling indicating a request to transmit or receive a sidelink positioning reference signal (SL-PRS); and a transmitter, which in operation, transmits the signaling to a second communication apparatus.

According to a fourth embodiment of the present disclosure, there is provided a communication method comprising: generating a sidelink positioning reference signal (SL-PRS); and transmitting the SL-PRS based on a signaling.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary 3GPP NR radio access network (NR-RAN) architecture to which exemplary embodiments of the present disclosure can be applied.

FIG. 2 depicts a schematic drawing which shows functional split between NG-RAN and 5G Core Network (5GC) to which exemplary embodiments of the present disclosure may be applied.

FIG. 3 depicts a sequence diagram for RRC (radio resource control) connection setup/reconfiguration procedures to which exemplary embodiments of the present disclosure may be applied.

FIG. 4 depicts a schematic drawing showing usage scenarios of Enhanced mobile broadband (eMBB), Massive Machine Type Communications (mMTC) and Ultra Reliable and Low Latency Communications (URLLC) to which exemplary embodiments of the present disclosure may be applied.

FIG. 5 shows a block diagram showing an exemplary 5G system architecture for vehicle to everything (V2X) communication in a non-roaming scenario to which exemplary embodiments of the present disclosure may be applied.

FIG. 6 shows an illustration of different signalings for triggering SL-PRS transmission according to various embodiments of the present disclosure.

FIG. 7 shows an illustration of a one-to-one resource reservation according to various embodiments of the present disclosure.

FIG. 8 shows an illustration of a one-to-multiple resource reservation according to various embodiments of the present disclosure.

FIG. 9 shows an illustration of a multiple-to-one resource reservation according to various embodiments of the present disclosure.

FIG. 10 shows an illustration of a one-to-two resource reservation according to various embodiments of the present disclosure.

FIG. 11 shows an illustration of a SL-PRS transmission based on a window according to various embodiments of the present disclosure.

FIG. 12 shows an illustration of a SL-PRS transmission based on a counter according to various embodiments of the present disclosure.

FIG. 13 shows an illustration of different signalings for triggering SL-PRS reception according to various embodiments of the present disclosure.

FIG. 14 shows an illustration of a SL-PRS reception based on a window according to various embodiments of the present disclosure.

FIG. 15 shows an illustration of a SL-PRS reception based on a counter according to various embodiments of the present disclosure.

FIG. 16 shows an illustration of different signalings for requesting SL-PRS according to various embodiments of the present disclosure.

FIG. 17 shows an illustration for assignment of time offset according to various embodiments of the present disclosure.

FIG. 18 shows an illustration for assignment of frequency offset according to various embodiments of the present disclosure.

FIG. 19 shows an illustration of a SL-PRS transmission triggered by a base station (gNB) or user equipment (UE) according to various embodiments of the present disclosure.

FIG. 20 shows an illustration of a SL-PRS reception triggered by a gNB or UE according to various embodiments of the present disclosure.

FIG. 21 shows an illustration of a request signaling for SL-PRS transmission according to various embodiments of the present disclosure

FIG. 22 shows an illustration of a request signaling for SL-PRS reception according to various embodiments of the present disclosure

FIG. 23 shows a flow chart illustrating a communication method according to various embodiments.

FIG. 24 shows a schematic block diagram of a communication apparatus in accordance with various embodiments.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

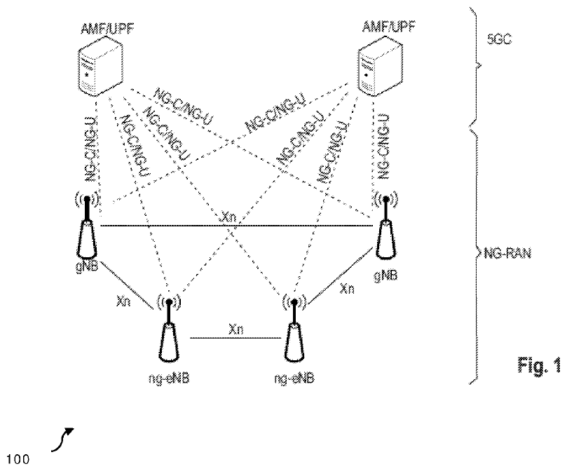

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the user equipment (UE). The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NGC interface and to the UPF (User Plane Function) (e.g., a particular core entity performing the UPF) by means of the NG-U interface. The NG-RAN architecture 100 is illustrated in FIG. 1 (see e.g., 3GPP TS 38.300 v16.3.0, section 4).

The user plane protocol stack for New Radio (NR) (see e.g., 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g., sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300. Further, sidelink communications is introduced in 3GPP TS 38.300v 16.3.0 . Sidelink supports UE-to-UE direct communication using the sidelink resource allocation modes, physical-layer signals/channels, and physical layer procedures (see for instance section 5.7 of TS 38.300).

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are Physical Random Access Channel (PRACH), Physical Uplink Shared Channel (PUSCH) and Physical Uplink Control Channel (PUCCH) for uplink and Physical Downlink Shared Channel (PDSCH), Physical Downlink Control Channel (PDCCH) and Physical Broadcast Channel (PBCH) for downlink. Further, physical sidelink channels include Physical Sidelink Control Channel (PSCCH), Physical Sidelink Shared Channel (PSSCH), Physical Sidelink Feedback Channel (PSFCH) and Physical Sidelink Broadcast Channel (PSBCH).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the orthogonal frequency-division multiplexing (OFDM) numerology (e.g., subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than a mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tu and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211v16.3.0 ).

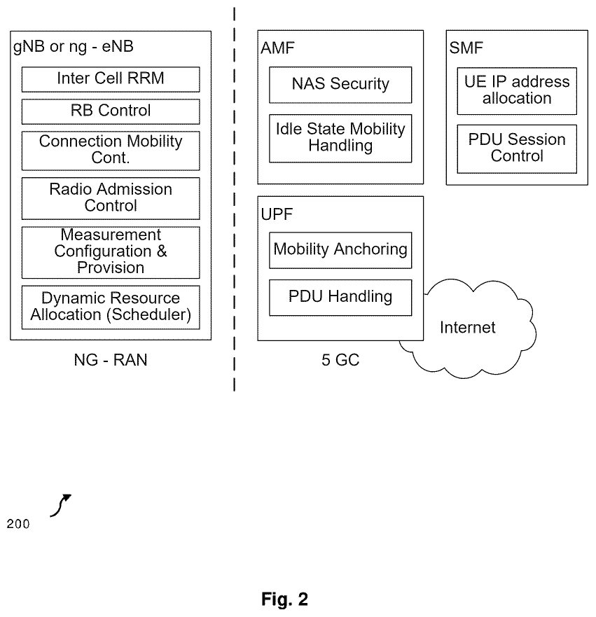

Schematic drawing 200 of FIG. 2 illustrates functional split between NG-RAN and 5GC. NG-RAN logical node is a gNB or ng-eNB. The 5GC has logical nodes Access and Mobility Management Function (AMF), User Plane Function (UPF) and Session Management Function (SMF).

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

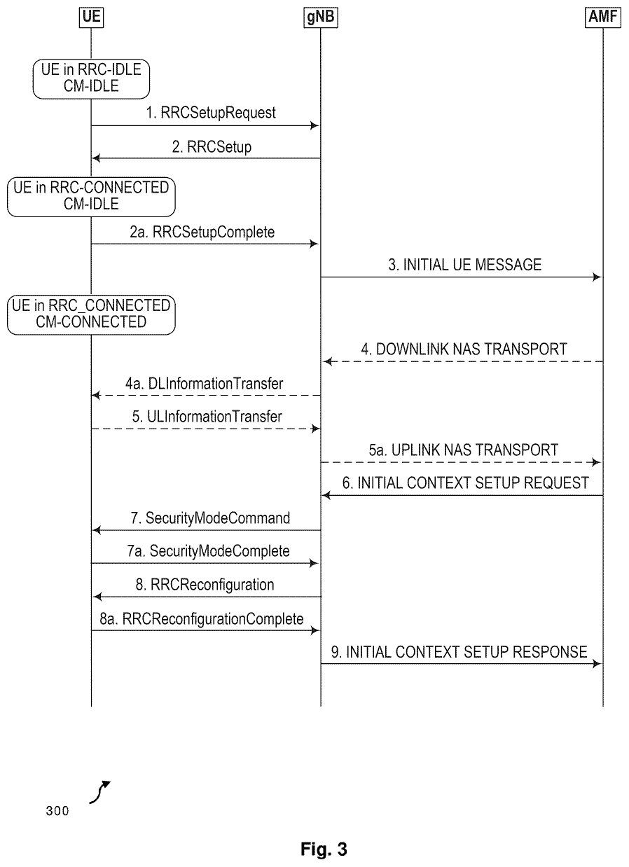

Sequence diagram 300 in FIG. 3 illustrates some interactions between a UE, gNB, and AMF (an 5GC entity) in the context of a transition of the UE from RRC_IDLE to RRC_CONNECTED for the NAS part (see TS 38.300v 16.3.0 ). The transition steps are as follows:
1. The UE requests to setup a new connection from RRC_IDLE.
2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502 reference [22] (3GPP TS 23.122: “Non-Access-Stratum (NAS) functions related to Mobile Station in idle mode”).
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signalling (protocol) used for UE and gNB configuration. In particular, this transition involves that the AMF prepares the UE context data (including e.g., PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

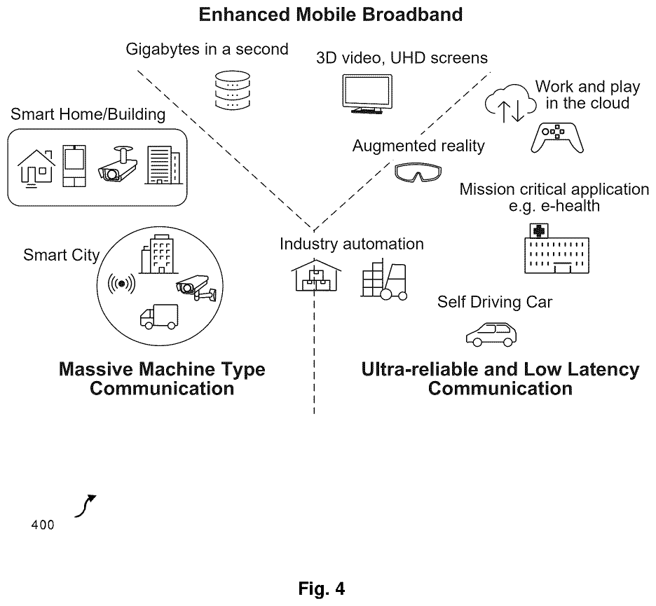

Schematic drawing 400 in FIG. 4 illustrates some use cases for 5G NR. In third generation partnership project new radio (3GPP NR), three use cases are being considered that have been envisaged to support a wide variety of services and applications by IMT-2020. The technical specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 4 illustrates some examples of envisioned usage scenarios for IMT for 2020 and beyond (see e.g., ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E−5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, mini-slot-based scheduling with flexible mapping, grant free (configured grant) uplink, mini-slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (such as, for example, URLLC) may be pre-empted by a transmission for a service type B (such as eMBB). Technology enhancements with respect to reliability improvement include dedicated Channel Quality Indicator/Modulation and Coding Scheme (CQI/MCS) tables for the target BLER of 1E−5.

The use case of mMTC (massive machine-type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 106 level), higher availability, packet sizes of up to 256 bytes, time synchronization down to the order of a few μs where the value can be one or a few μs depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g., as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QOS Flows with DRBs.

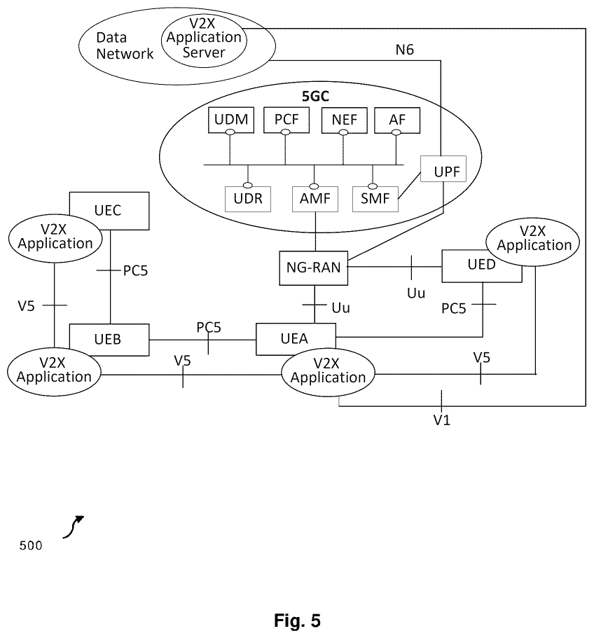

Block diagram 500 in FIG. 5 illustrates a 5G NR non-roaming reference architecture (see TS 23.287v16.4.0 , section 4.2.1.1). An Application Function (AF), e.g., an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g., QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g. operator services, Internet access or third party services. All of or a part of the core network functions and the application services may be deployed and running on cloud computing environments.

It is not straightforward to reuse existing downlink (DL) positioning reference signal (PRS) for SL PRS, as SL is a UE-to-UE transmission while DL is a gNB-to-UE transmission. DL-PRS is scheduled by gNB and gNB has full control of the uplink (UL) & DL resources. SL-PRS will be sent by each UE and the UEs have no control of SL resources required for transmission of the SL-PRS. In other words, SL transmissions are distributed among UEs, while DL transmissions are centralized from a gNB. The transmission is either sensing-based resource selection or random resource selection. In Scheme 2 (or mode-2), due to the lack of gNB central scheduling, transmission procedures need to be re-designed in consideration of potential over-the-air collision and congestion control.

Further differences are as follows. Power that is available to a UE for SL-PRS transmission is usually limited by battery life, while power is usually not an issue for DL-PRS since gNB is usually powered with electricity. Power control for distributed UEs are also not as simple as centralized gNB scheduling. Thus, power saving is more critical in SL-PRS but not much critical for DL-PRS. SL positioning mainly measures UE-to-UE distance; DL, on the other hand, mainly measures gNB-to-UE distance. SL positioning is more related to safety use cases, while DL is more for a gNB's knowledge. Thus, the latency requirement for SL positioning is more critical for safety consideration. A UE sending or receiving a SL-PRS transmission is most likely working in an unlicensed spectrum, whereas DL is usually in a licensed spectrum. SL spectrum may have interruption from other technologies (e.g., Wi-Fi), while DL spectrum is most likely with only DL and UL scheduling by the gNB. Therefore, there is a need to investigate and explore new solutions to address the differences between SL and DL, especially with consideration of congestion control, power saving, public safety and distributed scheduling from UEs for SL-PRS transmission.

At present, design of SL-PRS is mainly focused on the SL-PRS itself (namely sequence generation, initialization, time reference and frequency reference), and is mainly based on a single UE's point of view without any consideration for over-the-air signalings e.g., with other UEs or gNB. Transmission of a SL-PRS is only with some methodology on the resource allocation of one UE's perspective in terms of time and frequency. In the present disclosure, methods for interactions between UE-to-gNB, gNB-to-UE, and UE-to-UE for SL-PRS are thus proposed. Particularly, a solution for triggering the SL-PRS, including various aspects on how transmission and reception may be triggered with different power saving and congestion control techniques, are proposed.

The present disclosure proposes triggering procedures relating to SL-PRS based on a signaling for a UE. The procedure relating to SL-PRS may consist of transmission and reception of SL-PRS. The signaling may be based on a (pre-)configuration, a higher layer (MAC, RRC, PDCP, etc.) signaling, or PHY layer signaling. Further, the signaling can be from the UE transmitting the SL-PRS, a gNB, or one or more other UE(s). Advantageously, the signaling enables triggering of transmission or reception of SL-PRS.

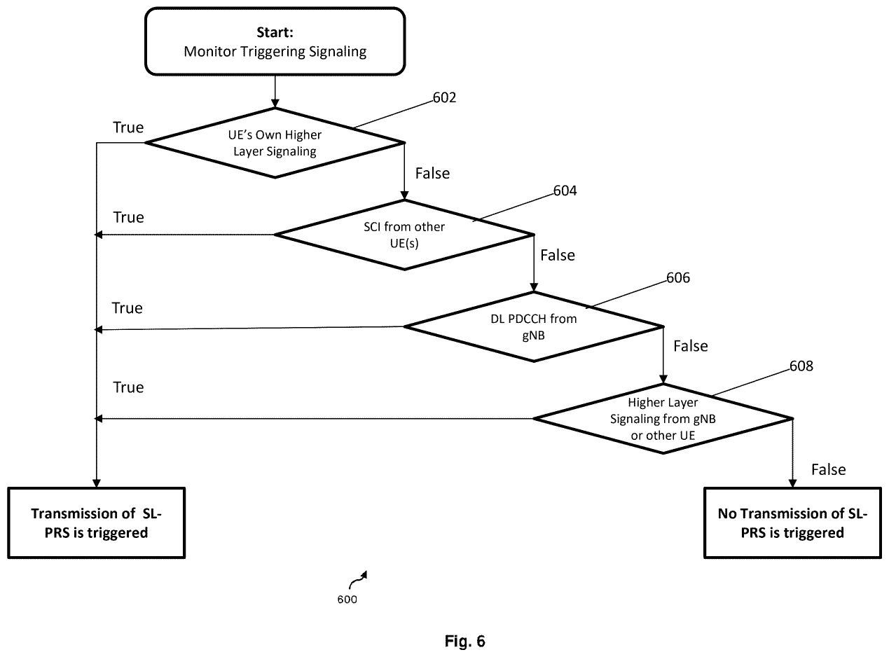

A UE may be configured to transmit a SL-PRS when triggered by a signaling. Referring to illustration 600 of FIG. 6, the signaling may be a higher layer signaling 602 associated with the UE (e.g., MAC, RRC, PDCP, application layer, or other similar higher layer signaling), a first stage or second stage sidelink control information (SCI) 604 received from another UE, a PDCCH 606 from a gNB (e.g., if the UE is within coverage of the gNB), or a higher layer signaling 608 from a gNB or other UE(s), thus enabling the origin of the signaling to be flexible depending on the application. Further, utilizing a higher layer signaling associated with the UE enables the signaling to be independent of other devices if necessary. It will be appreciated that various indications 602 to 608 in illustration 600 are not limited to be in any specific order.

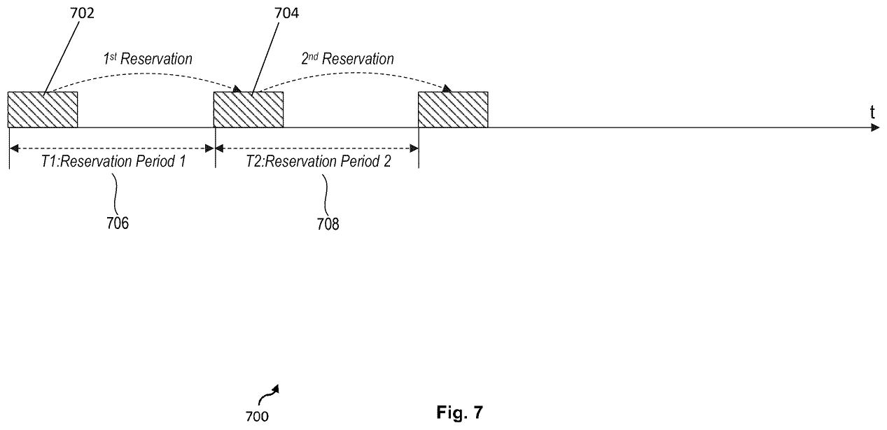

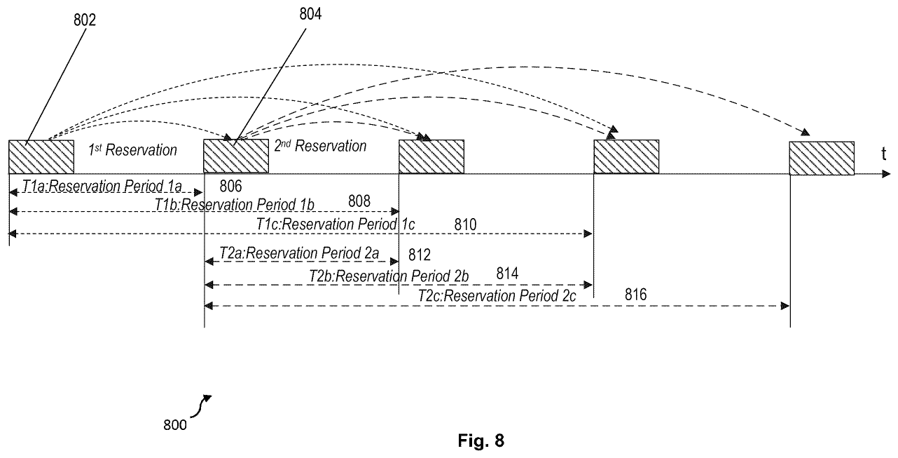

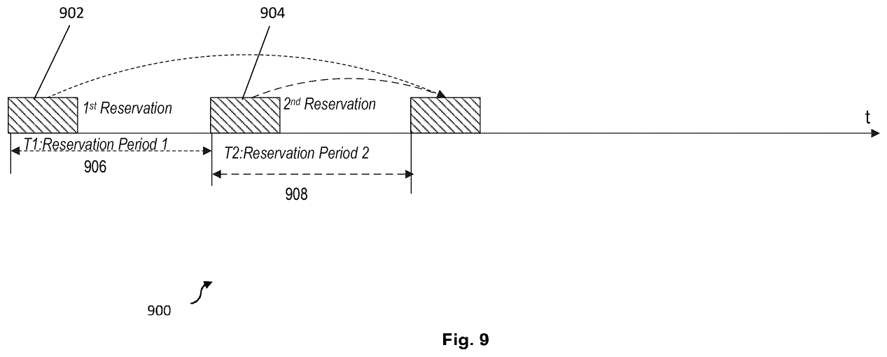

Depending on the type of scenario or use case, SL-PRS transmission may be aperiodic or periodic indicated by the triggering signaling. This enables the signaling to indicate how the SL-PRS may be transmitted (periodic or aperiodic) depending on application. In an implementation, a time period between each periodic SL-PRS transmission may be specified in the signaling, which may be useful to prevent collision with other transmissions or highlight an urgency of an event associated with the transmission (e.g., in a case of an emergency). Aperiodic or periodic transmissions may be with or without resource reservations for sensing-based or random resource selection. The resource reservation may be an indication sent by a UE to reserve one or more future time and/or frequency resources. Other UE(s) which receive the indication will not perform transmission in the reserved resources to avoid over-the-air collision. The resource selection may be a one-to-one reservation as shown in illustration 700 of FIG. 7 in which a first reservation 702 reserves one resource within a reservation period 706, and a second reservation 704 reserves one resource within a reservation period 708. It may also be a one-to-X (e.g., one-to-multiple) reservation as shown in illustration 800 of FIG. 8 (e.g., in which X=3 for a one-to-three reservation) in which a first reservation 802 reserves a first resource within a reservation period 806, a second resource within a reservation period 808, and a third resource within a reservation period 810, and a second reservation 804 reserves a first resource within a reservation period 812, a second resource within a reservation period 814, and a third resource within a reservation period 816. The resource selection may also be a Y-to-one (e.g., multiple-to-one) reservation as shown in illustration 900 of FIG. 9 (e.g., in which Y=2 for a two-to-one reservation) in which a first reservation 902 reserves one resource within a reservation period 906, and a second reservation 904 reserves the same resource within a reservation period 908.

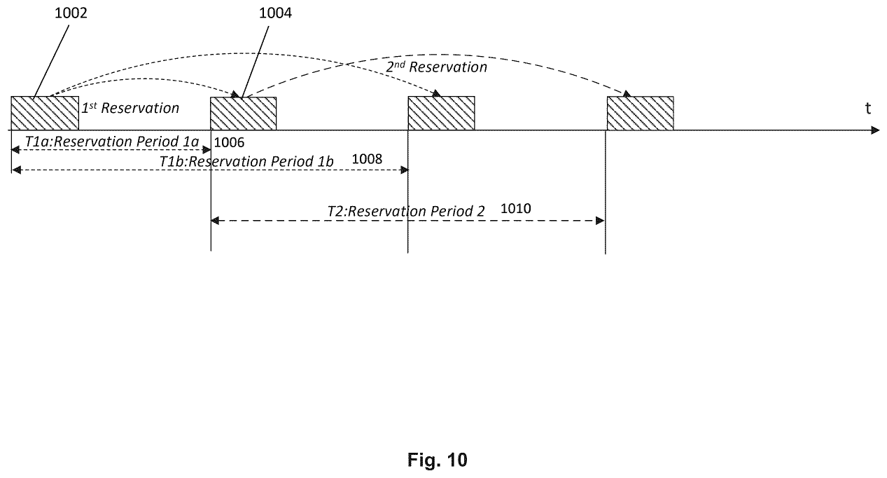

The reservation period may be defined in the signaling or (pre-)configured. The value of X may be different for different transmissions. For example, referring to illustration 1000 of FIG. 10, a first reservation 1002 may be a one-to-two resource reservation (e.g., X=2) in which it reserves a first resource within a reservation period 1006 and a second resource within a reservation period 1008, and a second reservation 1004 may be a one-to-one resource reservation (e.g., X=1) in which it reserves a resource within a reservation period 1010. For Y-to-1 reservations, different reservations may carry partial information. For example, a first reservation (e.g., first reservation 902 of FIG. 9) may indicate a time resource, while a second reservation (e.g., second reservation 904 of FIG. 9) may indicate a frequency resource. Advantageously, different modes of resource reservation may be implemented depending on application. In contrast, DL-PRS does not require different kinds of reservation since a gNB can dynamically schedule the DL-PRS. In an implementation, the reservation period(s) and/or information may be within a 1st stage SCI, a 2nd stage SCI or both. For example, a 1st & 2nd reservations may be with a 1st stage SCI (e.g., according to Rel. 16 specifications) and a 3rd reservation with a 2nd stage SCI; or the 1st reservation may be with the 1st stage SCI, and the 2nd and 3rd reservation with the 2nd stage SCI. This advantageously enables 1st stage and/or 2nd stage SCI to be used as the signaling to provide parameters for SL-PRS resource reservation.

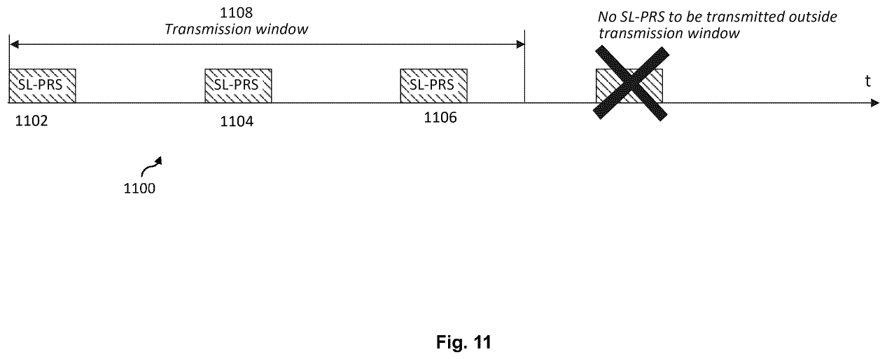

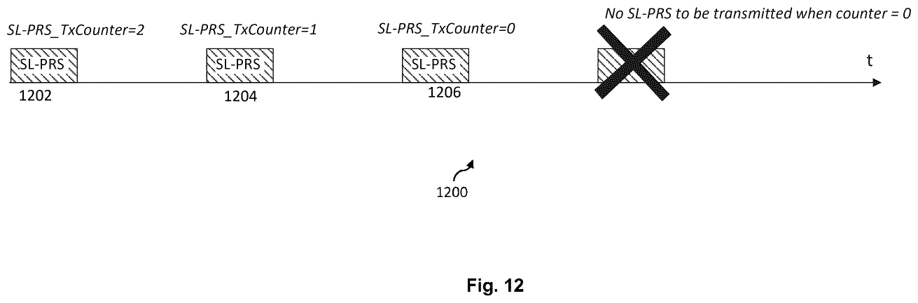

For power saving and congestion control considerations, a SL-PRS transmission may be associated with a window. For example, referring to illustration 1100 of FIG. 11, SL-PRS transmissions 1102, 1104 and 1106 may be configured to be transmitted within a transmission window 1108, such that no SL-PRS is to be transmitted outside the transmission window 1108. A SL-PRS transmission may also be associated with a counter. For example, referring to illustration 1200 of FIG. 12, SL-PRS transmissions 1202, 1204 and 1206 may be configured to be transmitted while a counter is still valid and running, such that no SL-PRS is to be transmitted after the counter runs out. Further, a SL-PRS transmission may also be associated with a timer, such that no SL-PRS is to be transmitted after the timer runs out. The window, counter or timer may be (pre-)configured, specified by the technical specifications or vendors, self-generated by a UE, or other similar implementations. Further, the UE receiving or decoding a SL-PRS may be configured to enter power saving mode if it is not required to receive or decode the SL-PRS. In an implementation, alternatively or in addition to indication of a transmission window, timer or counter, the signaling may indicate a maximum or minimum number of SL-PRS transmissions that can be transmitted, which may be useful for power consumption and/or congestion control. These measures advantageously enable power saving and congestion control for SL-PRS transmission and reception.

In an implementation, the signaling triggering the transmission of SL-PRS may carry all or part of a plurality of parameters relating to the SL-PRS transmission, to enable flexibility of SL-PRS parameter provisions depending on application. The parameters may be based on a (pre-)configuration, obtained from a gNB, obtained from one or more other UE(s), self-generated by the UE that transmits the SL-PRS, or other similar implementations. The SL-PRS related parameters may include but are not limited to the following: subcarrier spacing (SCS), carrier phase (CP), Point A, resource set identifier (ID), periodicity, slot offset, reputation factor, time gap, muting time locations, SFNO offset, comb size, bandwidth, start physical resource block (PRB), number of symbols, resource ID, sequence ID, resource element offset, symbol offset, quasi-colocation (QCL) information, subset for angle of departure (AoD) prioritization, and other similar parameters.

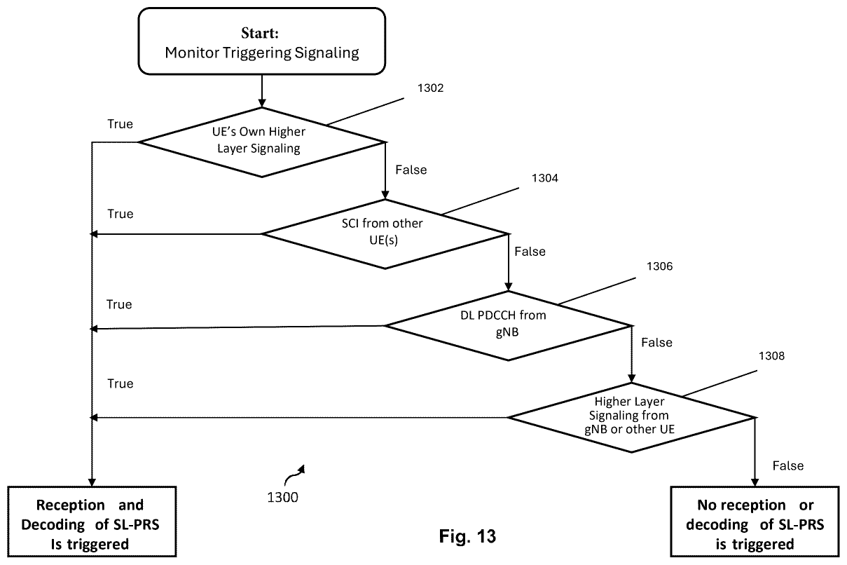

A UE may be configured to receive and decode a SL-PRS when triggered by a signaling. Referring to illustration 1300 of FIG. 13, the signaling may be a higher layer signaling 1302 associated with the UE (e.g., MAC, RRC, PDCP, application layer, or other similar higher layer signaling), a first stage or second stage sidelink control information (SCI) 1304 received from another UE, a PDCCH 1306 from a gNB (e.g., if the UE is within coverage of the gNB), or a higher layer signaling 1308 from a gNB or other UE(s), thus enabling the origin of the signaling to be flexible depending on the application. Further, utilizing a higher layer signaling associated with the UE enables the signaling to be independent of other devices if necessary). It will be appreciated that various indications 1302 to 1308 in illustration 1300 are not limited to be in any specific order.

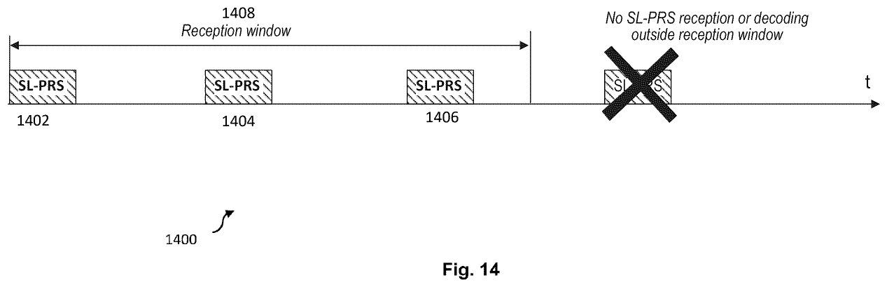

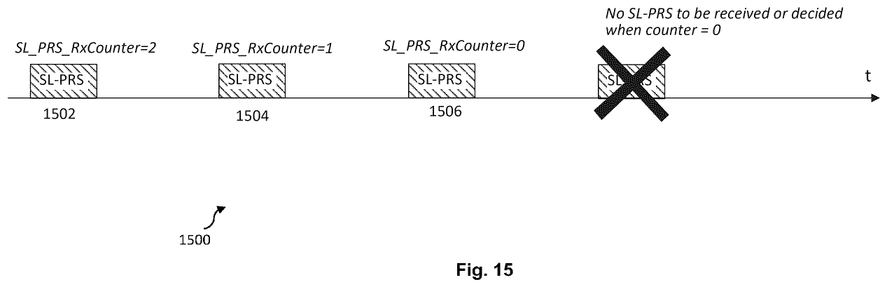

For power saving and congestion control considerations, reception of a SL-PRS may be associated with a window. For example, referring to illustration 1400 of FIG. 14, SL-PRS 1402, 1404 and 1406 may be configured to be received and/or decoded within a reception window 1408, such that no SL-PRS is to be received and/or decoded outside the reception window 1408. Reception of SL-PRS may also be associated with a counter. For example, referring to illustration 1500 of FIG. 15, SL-PRS 1502, 1504 and 1506 may be configured to be received and/or decoded while a counter is still valid and running, such that no SL-PRS is to be received and/or decoded after the counter runs out. Further, reception of a SL-PRS may also be associated with a timer, such that no SL-PRS is to be received and/or decoded after the timer runs out. The window, counter or timer may be (pre-)configured, specified by the technical specifications or vendors, self-generated by a UE, or other similar implementations. In an implementation, alternatively or in addition to indication of a transmission window, timer or counter, the signaling may indicate a maximum or minimum number of SL-PRS transmissions that can be received and/or decoded, which may be useful for power consumption and/or congestion control. Further, the UE receiving and/or decoding a SL-PRS may be configured to enter power saving mode if it is not required to receive and/or decode the SL-PRS. These measures advantageously enable power saving and congestion control for SL-PRS transmission and reception.

A UE (e.g., a requestor UE) may be configured to request one or more other UE(s) (e.g., one or more requested UE(s)) to transmit a SL-PRS for different use cases. The requested UE(s) may be all UEs that have received the requestor UE's request, or only certain anchor UE(s) (e.g., based on a type of UE such as road side unit (RSU) or other UE type(s)). The requestor UE may also be configured to request one or more other UE(s) to receive the requestor UE's subsequent SL-PRS transmission. The request to transmit or receive a SL-PRS transmission may be based on SCI triggering and may include a request that is relayed by a gNB (e.g., via a UL and then via a DL transmission). For example, a requesting UE may transmit a request message to its gNB via UL (e.g., PUCCH or PUSCH), and the gNB may use DL (e. g, PDCCH and/or PDSCH) to request other UE(s) to send a SL-PRS to the requesting UE (e.g., via either unicast/groupcast/broadcast). By indicating one or more UEs or one or more types of UEs for transmitting or receiving the SL-PRS in the signaling, broadcast/groupcast of signaling can advantageously be enabled while selectively indicating which UE to transmit or receive the SL-PRS. Further, requesting of a SL-PRS transmission or reception is useful for latency critical use cases and congestion control.

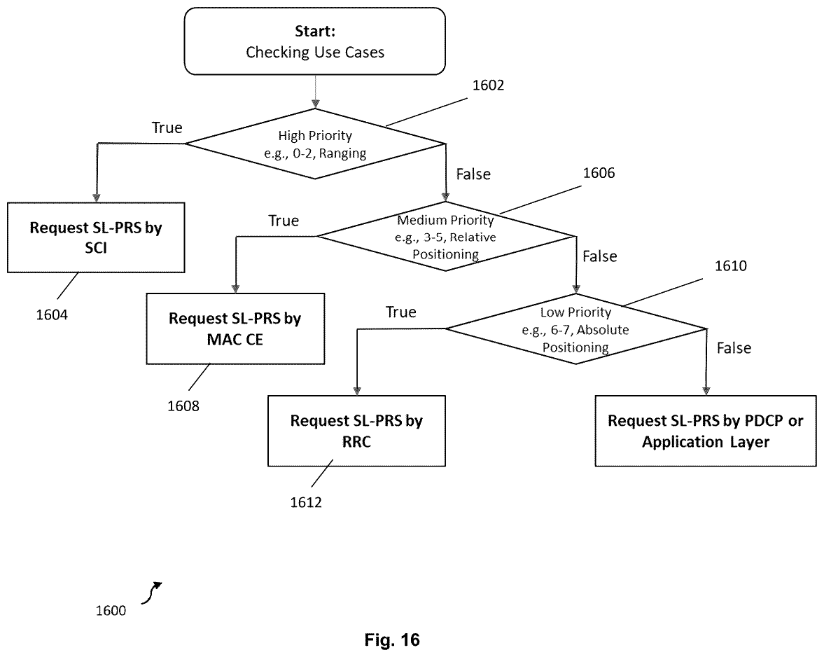

Depending on different priorities or use cases, a UE may be configured to use PHY signaling (e.g., 1st stage or 2nd stage SCI) or a higher layer signaling (e.g., MAC-CE, RRC, or other similar higher layer signaling) to request a PRS transmission or reception, based on a priority associated with the PRS transmission. This enables transmission mode of signaling to be defined depending on a priority associated with the SL-PRS, so that a more efficient transmission mode may be provided for a higher priority. For example, referring to illustration 1600 of FIG. 16, for a high priority use case 1602 (e.g., a priority level of 0, 1, 2), SL-PRS transmission or reception may be requested via SCI 1604 for a simple and fast response, which is advantageous especially for safety use cases. A potential use case for using SCI request as a signaling for SL-PRS may be for ranging applications to take advantage of the faster processing time. However, horizontal and vertical relative and/or absolute positioning parameters may be lacking when utilizing SCI request.

For a medium priority use case 1606 (e.g., a priority level of 3, 4, 5), SL-PRS may be requested via MAC-CE 1608. A MAC-CE request typically requires more time to measure and calculate a horizonal and vertical distance (e.g., for geo-positioning purposes) which may be better suited for use in locations with stacked road structures such as viaducts and bridges. A potential use case for using MAC-CE request as a signaling for SL-PRS may be for relative positioning applications, in which RSUs may be placed on viaducts to assist in navigating drivers into a correct lane.

Further, for a low priority use case 1610 (e.g., a priority level of 6, 7), SL-PRS may be requested via a RRC request 1612. A RRC request typically provides the most accurate positioning parameters among the other use cases (e.g., compared with a SCI request or a MAC-CE request), but is also the most time-consuming and requires GNSS assistance. A potential use case for using RRC request as a signaling for SL-PRS may be for absolute positioning and geofencing (e.g., either Scheme 1 or Scheme 2) applications.

It will be appreciated that various use cases 1602, 1606 and 1610 as shown in illustration 1600 are not meant to be limited to be in any specific order or priority. Further, the various use cases 1602, 1606 and 1610 are mere examples and are not limited to the specified signaling, priority value or use case.

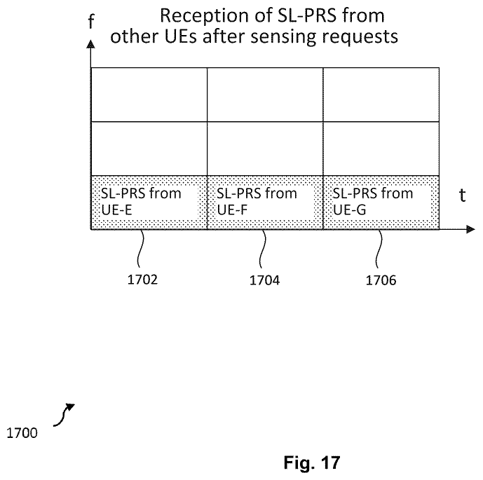

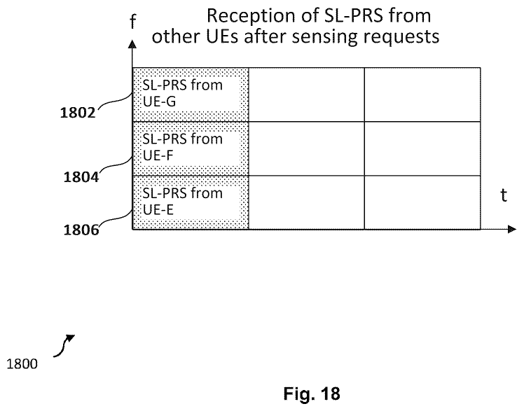

A UE (for example, a requestor UE) may be configured to explicitly request one or more other UE(s) to transmit a SL-PRS to the requestor UE. If the requests are carried by unicast messages, the requestor UE may be configured to assign a different time offset or frequency offset to the requested one or more other UE(s) (e.g., the requestor UE acting as a scheduling UE for the SL-PRS transmission). For example, illustration 1700 of FIG. 17 depicts a time offset assignment in which a first SL-PRS is assigned to be received by a requestor UE from a first UE at a time resource 1702, a second SL-PRS is assigned to be received by the requestor UE from a second UE at a time resource 1704, and a third SL-PRS is assigned to be received by the requestor UE from a third UE at a time resource 1706. By adopting different levels of time offset, time resources can be different OFDM symbols, slots, sub-frames, and other similar resources. In another example, illustration 1800 of FIG. 18 depicts a frequency offset assignment in which a first SL-PRS is assigned to be received by a requestor UE from a first UE at a frequency resource 1802, a second SL-PRS is assigned to be received by the requestor UE from a second UE at a frequency resource 1804, and a third SL-PRS is assigned to be received by the requestor UE from a third UE at a frequency resource 1806. By adopting different levels of frequency offset, frequency resources can be different resource elements (REs), resource blocks (RBs), sub-channels, and other similar resources. It is also possible to combine both time and frequency offsets for the SL-PRS transmission. By indicating a time or frequency offset for SL-PRS transmission when transmitting the signaling via unicast, it is possible to improve resource management for the SL-PRS transmission. If the requests are carried by groupcast or broadcast messages, the requestor UE may not be able to assign the offsets. Instead, the one or more other UE(s) may be configured to derive the offsets by themselves. The derivation may be based on an identifier (ID) such as a synchronization ID, a Radio Network Temporary Identifier (RNTI), or other similar parameters.

In an example, public service vehicles may be configured to have a dedicated ID, zone ID, and resources to avoid SL-PRS over-the-air collision. These public service vehicles may be configured to transmit a signalling to request nearby pedestrian UE (P-UE) and/or vehicular UE (V-UE) to listen to the emergent SL-PRS to give way. Further, a P-UE may also request one or more nearby V-UE(s) to broadcast their SL-PRS for the P-UE's safety consideration (especially when the P-UE is crossing a road) to assess whether it is in dangerous situation by measuring and calculating a distance based on the SL-PRS received from the V-UE(s).

In an implementation, for a UE (e.g., an anchor UE) that is configured to periodically broadcast SL-PRS, the SL-PRS may be sent together or attached with a SL-SSB (e.g., with a same periodicity), or separately broadcasted with a different periodicity. Other UEs may be configured to use those broadcasted SL-PRSs to measure and calculate relative positions. The anchor UE may be a RSU, or a public service vehicle (e.g., bus, ambulance, fire engine, police car, or other similar public service vehicles). It will be appreciated that a UE may be configured to transmit the SL-PRS via a broadcast, groupcast or unicast in a periodic or aperiodic manner depending on application.

For example, public service vehicles (e.g., ambulance, fire engine, police car) may be configured to periodically broadcast SL-PRS during an emergency. Other type of vehicles will give way upon successfully receiving and decoding the broadcasted SL-PRS. One or more RSUs may be placed on viaducts, especially those with a complex network, to assist in navigating drivers into a correct lane ID (e.g., by offset assignment or resource allocation). With implementation of zone IDs in a viaduct network, a vehicle on a top layer of a viaduct will not be mistakenly marked as dangerous to vehicles on lower layers. RSUs may also be configured to broadcast SL-PRS associated with a specific zone ID (e.g., by offset assignment or resource allocation) to forbid vehicles/pedestrians to enter certain restricted areas (e.g., geo-fencing). Further, RSUs installed in a multi-storey mall or carpark can broadcast, groupcast or unicast SL-PRS for V-UE or P-UE to the correct level (e.g., to indicate areas with more available parking lots, indicate an emergency exit, etc.). This may involve one or more of zone ID, offset assignment, ID filtered reception, and other parameters, and may also require application layer assistance.

Backward compatibility for Rel. 18 UE with Rel. 16/17 UE is also important, especially for cases in which Rel. 16/17 and Rel. 18 UEs are in a same spectrum or resource pool. To ensure the quality of service, Rel. 16/17 UEs need to be able to at least understand some of the Rel. 18 signaling. For instance, a reservation sent by a Rel. 18 UE need to be understood by Rel. 16/17 UEs to avoid over-the-air collision. In an implementation, for backward compatibility with Rel. 16 and Rel. 17 UEs, Rel. 18 UEs may be configured to use a Rel. 18 2nd stage SCI and/or Rel. 18 2nd stage PSSCH to indicate SL-PRS usage. Rel. 16/17 UEs may then be configured to discard the Rel. 18 2nd stage SCI and/or PSSCH upon decoding the field for 1st stage SCI or 2nd stage SCI. Further, although some UEs may be able to receive and decode the Rel. 18 PSSCH, it may not be necessary for them to do so, and they can also simply discard the PSSCH for power saving purposes. Alternatively, the same Rel. 16 and Rel. 17 2nd stage SCI may be used by Rel. 18 UEs for transmission. Specific destination ID(s) may be used for SL-PRS transmission. Rel. 16/17 UEs may be configured to skip PSSCH decoding after interpretation of the destination ID. Additionally, some fields in the 1st stage SCI or 2nd stage SCI may be configured to be of any value if decoding of PSSCH is not required.

As an example, a Rel. 18 UE sends the SL-PRS and the Rel. 18 2nd stage SCI relating to SL-PRS. Then, another Rel.18 UE receives the SL-PRS and the Rel. 18 2nd stage SCI. A Rel. 16/17 UE may discard the SL-PRS and the Rel. 18 2nd stage SCI. Further, both of the Rel. 16/17 UE and the another Rel. 18 UE may receive 1st stage SCI and/or the Rel. 16 and Rel. 17 2nd stage SCI.

As an alternative example, a Rel. 18 UE sends the Rel. 18 2nd stage SCI relating to SL-PRS. Then, another Rel. 18 UE receives the Rel. 18 2nd stage SCI and transmits the SL-PRS based on the Rel. 18 2nd stage SCI. A Rel. 16/17 UE may discard the Rel. 18 2nd stage SCI. Further, both of the Rel. 16/17 UE and the another Rel. 18 UE may receive 1st stage SCI and/or the Rel. 16 and Rel. 17 2nd stage SCI.

Certain parameter(s) (e.g., resource set ID, destination ID) may be (pre-)defined for reception filtering so that each UE can understand the assigned SL-PRS resource(s) for congestion control considerations. In an implementation, a new or re-used ID may be designated as a priority parameter. For example, for a 2-bit 1 st (or 2nd) stage SCI information, public service vehicles (e.g., ambulance, fire engine) may be set to a priority parameter of 0, huge vehicles (e.g., bus, trucks) may be set to a priority parameter of 1, small vehicle (cars, motorcycles) may be set to a priority parameter of 2, and pedestrians may be set to a priority parameter of 3. Based on the set priority parameter and receiving rule(s), corresponding resource(s) may be utilized. For example, UEs marked with a resource set ID of 0 may be configured to monitor all PRS resources with resource set IDs 0-3, while UEs marked with a resource set ID of 3 may be configured to monitor only PRS resources with a resource ID of 0. This advantageously enables SL-PRS resources to be assigned to an appropriate SL-PRS based on an identifier, for improved transmission efficiency of SL-PRS. The SL-PRS generating parameters may be obtained from a gNB, another UE, or self-generated by the UE transmitting or receiving the SL-PRS. In another implementation, some UE property related parameters (e.g., resource set ID) may be (pre-)defined based on a zone associated with the UE (e.g., geographical areas, altitudes ranges, type of land like road/path/building). Different types of UEs within a same zone may be configured to use a same ID. This may be applicable for certain scenarios such as pedestrians requesting a position from vehicles in a same or different zone (or vice versa). Further, some parameters such as small-scale offset (within a resource block (RB) or slot, for example a resource element (RE), OFDM symbol, or other similar resource) may be (pre-)defined. The offset may be defined together with defining a referencing time and/or frequent point within a triggering signaling, or self-generated by the UE transmitting or receiving the SL-PRS. The other parameters may be dynamically configured (e.g., resource ID, periodicity, large-scale offsets like slot/frame/PRB, and other similar parameters). Alternatively, different positioning solutions (e.g., round trip time (RTT), SL-AoA, SL time difference of arrival (SL-TDOA), and other similar positioning solutions) may be used for distinguishment purposes.

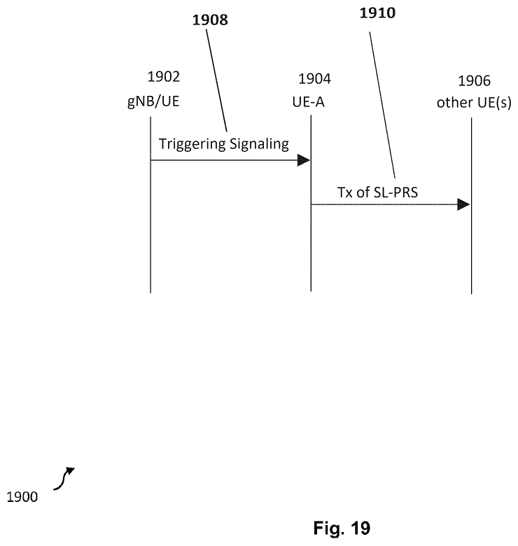

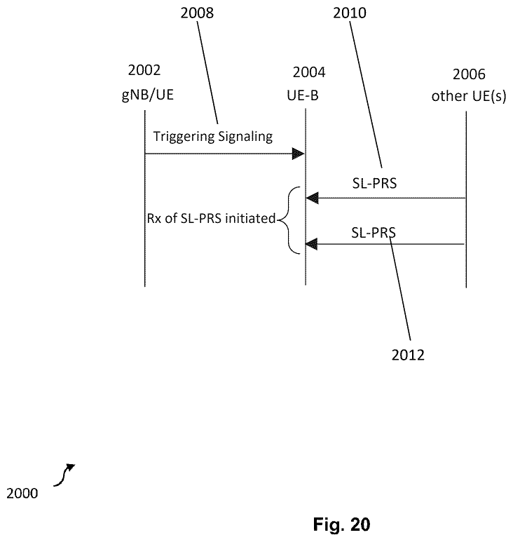

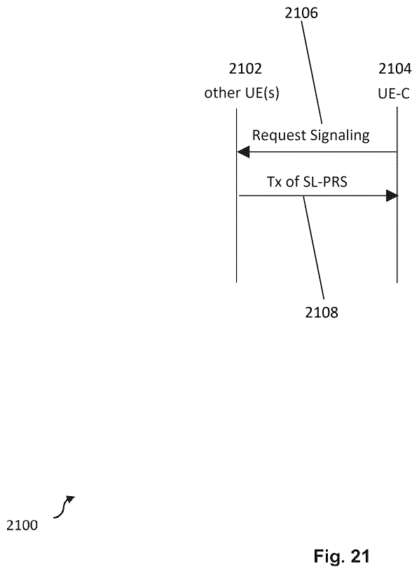

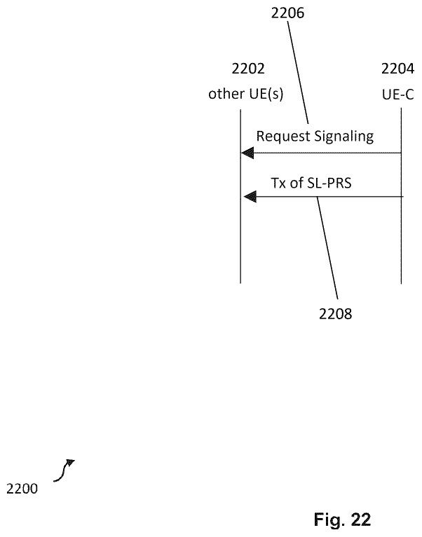

Examples of signaling for gNB/UE triggered SL-PRS transmission, reception and request of SL-PRS are shown in FIGS. 19-22. Illustration 1900 of FIG. 19 depicts signaling for SL-PRS transmission, in which a gNB or UE 1902 transmits a signaling 1908 requesting for transmission of a SL-PRS 1910 to a UE 1904, and the UE 1904 transmits the SL-PRS 1910 to another UE 1906 based on the signaling. Illustration 2000 of FIG. 20 depicts signaling for SL-PRS reception, in which a gNB or UE 2002 transmits a signaling 2008 requesting for reception of SL-PRS, and the UE 2004 receives the two SL-PRS 2010 and 2012 from another UE 2006 based on the signaling. Illustration 2100 of FIG. 21 depicts another signaling for SL-PRS transmission, in which a UE 2104 transmits a signaling 2106 requesting for transmission of a SL-PRS 2108 to one or more other UE(s) 2102, and the UE(s) 2102 transmits the SL-PRS 2108 to the UE 2104 based on the signaling. Further, illustration 2200 of FIG. 22 depicts another signaling for SL-PRS reception, in which a UE 2204 transmits a signaling 2206 requesting for reception of a SL-PRS 2208 to one or more other UE(s) 2202, and the UE(s) 2202 receives the SL-PRS 2208 from the UE 2204 based on the signaling. It will be appreciated to a person skilled in the art that the signaling scenarios for SL-PRS transmission are not limited to the examples depicted in FIGS. 19-22.

The solutions proposed in the present disclosure are applicable for a dedicated or shared resource pool, and any time/frequency offset and/or signaling may have the same or different parameters based on whether a dedicated or shared resource pool is utilized. Further, the solutions proposed in the present disclosure may be applied for either sidelink positioning Scheme 1 (which is gNB centric) or Scheme 2 (which is UE autonomous).

In an implementation, the triggering and/or request for SL-PRS may be via an explicit or implicit signaling. An explicit signaling may be a PHY or higher layer signaling from a gNB, another UE or self-generated by the UE triggering and/or requesting the SL-PRS. An implicit signaling may be a SL-PRS triggering that is inferred by other non-explicit signaling (e.g., specific sequence for RS or PSFCH, specific time or frequency resource allocation for PSCCH/PSSCH/PSFCH, synchronization ID, etc.).

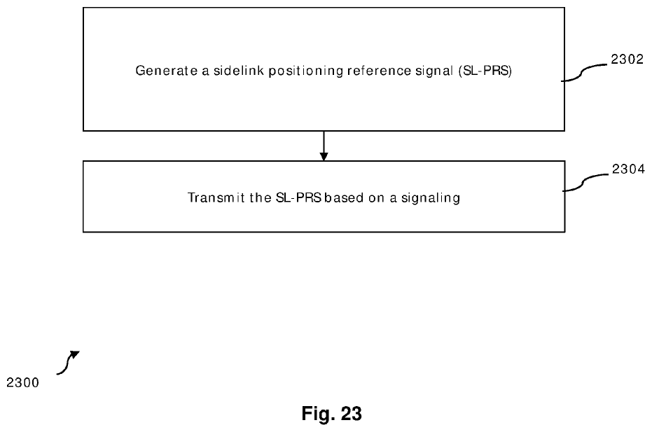

FIG. 23 shows a flow diagram 2300 illustrating a communication method according to various embodiments. In step 2302, a sidelink positioning reference signal (SL-PRS) may be generated. In step 2304, the SL-PRS may be transmitted based on a signaling.

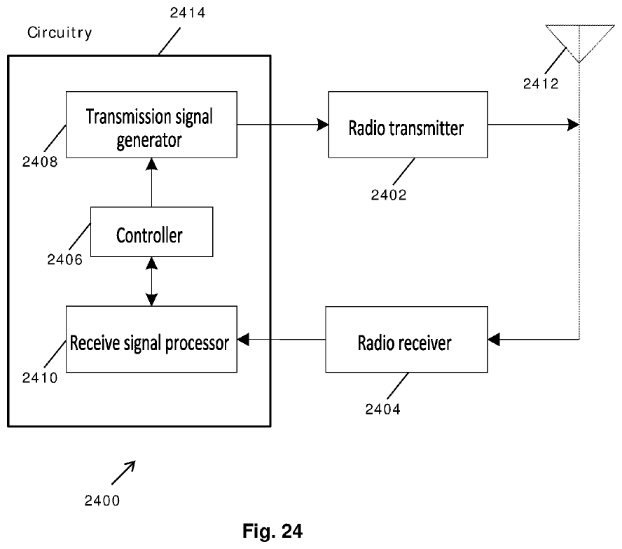

FIG. 24 shows a schematic, partially sectioned view of the communication apparatus 2400 that can be implemented for in accordance with various embodiments and examples as shown in FIGS. 1 to 23. The communication apparatus 2400 may be implemented as a UE or base station according to various embodiments.

Various functions and operations of the communication apparatus 2400 are arranged into layers in accordance with a hierarchical model. In the model, lower layers report to higher layers and receive instructions therefrom in accordance with 3GPP technical specifications. For the sake of simplicity, details of the hierarchical model are not discussed in the present disclosure.

As shown in FIG. 24, the communication apparatus 2400 may include circuitry 2414, at least one transmitter 2402, at least one receiver 2404, and at least one antenna 2112 (for the sake of simplicity, only one antenna is depicted in FIG. 24 for illustration purposes). The circuitry 2414 may include at least one controller 2406 for use in software and hardware aided execution of tasks that the at least one controller 2406 is designed to perform, including control of communications with one or more other communication apparatuses in a wireless network. The circuitry 2414 may furthermore include at least one transmission signal generator 2108 and at least one receive signal processor 2410. The at least one controller 2406 may control the at least one transmission signal generator 2408 for generating signals (for example, a signaling for SL-PRS transmission or reception) to be sent through the at least one radio transmitter 2402 to one or more other communication apparatuses and the at least one receive signal processor 2410 for processing signals (for example, a a signaling for SL-PRS transmission or reception) received through the at least one radio receiver 2404 from the one or more other communication apparatuses under the control of the at least one controller 2406. The at least one transmission signal generator 2408 and the at least one receive signal processor 2410 may be stand-alone modules of the communication apparatus 2400 that communicate with the at least one controller 2406 for the above-mentioned functions, as shown in FIG. 24. Alternatively, the at least one transmission signal generator 2408 and the at least one receive signal processor 2410 may be included in the at least one controller 2406. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 2402, at least one radio receiver 2404, and at least one antenna 2412 may be controlled by the at least one controller 2406.

The communication apparatus 2400, when in operation, provides functions required for transmission and reception of SL-PRS. For example, the communication apparatus 2400 may be a UE, and the circuitry 2414 may, in operation, generate a SL-PRS. The transmitter 2402 may, in operation, transmit the SL-PRS based on a signaling.

The signaling may indicate whether the SL-PRS is periodic or aperiodic, and the transmitter may be further configured to transmit the SL-PRS periodically or aperiodically based on the signaling. The transmitter 2402 may be further configured to transmit the SL-PRS with a resource reservation, the resource reservation being a one-to-one reservation, a one-to-multiple reservation, or a multiple-to-one reservation. The signaling may be a 1st stage sidelink control information (SCI) and/or a 2nd stage SCI, and the resource reservation is based on the 1st stage SCI, the 2nd stage SCI, or both 1st stage SCI and 2nd stage SCI.

The transmitter 2402 may be further configured to transmit the SL-PRS within a window, a counter, or a timer. The signaling may comprise one or more parameters associated with the SL-PRS, and the transmitter 2402 may be configured to transmit the SL-PRS based on the one or more parameters. The signaling may be a higher layer signaling associated with the communication apparatus. The receiver may, which in operation, receive the signaling from another communication apparatus, the signaling being a 1st stage sidelink control information (SCI) and/or a 2nd stage SCI, a Physical Downlink Control Channel (PDCCH), or a higher layer signaling associated with the another communication apparatus.

The communication apparatus 2400 may be a UE, and the receiver 2404 may, in operation, receive a SL-PRS based on a signaling. The circuitry 2414 may, in operation, decode the SL-PRS.

The receiver 2404 may be further configured to receive the SL-PRS within a window, a counter, or a timer. The signaling may be a higher layer signaling associated with the communication apparatus, or wherein the receiver 2404 may be further configured to receive the signaling from another communication apparatus, the signaling being a 1st stage sidelink control information (SCI) and/or a 2nd stage SCI, a Physical Downlink Control Channel (PDCCH), or a higher layer signaling associated with the another communication apparatus. The communication apparatus may be a Rel. 16/17 user equipment (UE), the another communication apparatus may be a Rel. 18 UE, the 2nd stage SCI may be a Rel. 18 2nd stage SCI, and the signaling may further comprise a Rel. 18 Physical Sidelink Shared Channel (PSSCH), and the circuitry 2414 may be further configured to discard the Rel. 18 2nd stage SCI and the Rel. 18 PSSCH when decoding the signaling. The communication apparatus may be a Rel. 16/17 user equipment (UE), the another communication apparatus may be a Rel. 18 UE, the 2nd stage SCI may be a Rel. 16/17 2nd stage SCI and the signaling may comprise a Rel. 18 PSSCH, and the circuitry 2414 may be further configured to skip decoding the Rel. 18 PSSCH when decoding the signaling. The signaling may comprise a resource set identifier associated with the SL-PRS, and the receiver 2414 may be configured to receive the SL-PRS based on a comparison of the resource set identifier with an identifier associated with the communication apparatus.

The communication apparatus 2400 may be a first communication apparatus, and the circuitry 2414 may, in operation, generate a signaling indicating a request to transmit or receive a SL-PRS. The transmitter 2402 may, in operation, transmit the signaling to a second communication apparatus.

The signaling may indicate one or more communication apparatuses or one or more types of communication apparatus for transmitting the SL-PRS. The transmitter 2402 may be further configured to transmit the signaling as a physical layer (PHY) signaling or a higher layer signaling based on a priority associated with the SL-PRS. The signaling may further indicate a time and/or frequency resource for transmitting the SL-PRS. The transmitter 2402 may be further configured to transmit the signaling periodically via a unicast, groupcast or broadcast.

### Control Signals

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the first stage sidelink control information (SCI) or the second stage SCI.

### Base Station

In the present disclosure, the base station may be a Transmission Reception Point (TRP), a cluster head, an access point, a Remote Radio Head (RRH), an eNodeB (eNB), a gNodeB (gNB), a Base Station (BS), a Base Transceiver Station (BTS), a base unit or a gateway, for example. Further, in sidelink communication, a terminal may be adopted instead of a base station. The base station may be a relay apparatus that relays communication between a higher node and a terminal. The base station may be a roadside unit as well.

### Uplink/Downlink/Sidelink

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### Data Channels/Control Channels

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### Reference Signals

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

### Time Intervals

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### Frequency Bands

The present disclosure may be applied to any of a licensed band and an unlicensed band.

### Communication

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### Antenna Ports

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

As described above, the embodiments of the present disclosure provide an advanced communication system, communication methods and communication apparatuses that advantageously enables transmission and reception of SL-PRS.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

Some non-limiting examples of such communication apparatus include a phone (e.g., cellular (cell) phone, smart phone), a tablet, a personal computer (PC) (e.g., laptop, desktop, netbook), a camera (e.g., digital still/video camera), a digital player (e.g., digital audio/video player), a wearable device (e.g., wearable camera, smart watch, tracking device), a game console, a digital book reader, a telehealth/telemedicine (e.g., remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

The present disclosure may refer to the following statements:
Statement 1. A communication apparatus, comprising: circuitry, which in operation, generates a sidelink positioning reference signal (SL-PRS); and a transmitter, which in operation, transmits the SL-PRS based on a signaling.
   As it is not straightforward to reuse existing DL-PRS techniques for SL-PRS transmission (since SL is a UE-to-UE transmission), the feature “transmit the SL-PRS based on a signaling” introduces a signaling for transmission of SL-PRS to advantageously provide a solution on how SL-PRS can be transmitted by a UE.
Statement 2. The communication apparatus of Statement 1, wherein the signaling indicates whether the SL-PRS is periodic or aperiodic, and the transmitter is further configured to transmit the SL-PRS periodically or aperiodically based on the signaling.
   The feature “transmit the SL-PRS periodically or aperiodically based on the signaling” enables the signaling to indicate how the SL-PRS may be transmitted (periodic or aperiodic) depending on application.
Statement 3. The communication apparatus of Statement 1, wherein the transmitter is further configured to transmit the SL-PRS with a resource reservation, the resource reservation being a one-to-one reservation, a one-to-multiple reservation, or a multiple-to-one reservation.
   The feature “transmit the SL-PRS with a resource reservation, the resource reservation being a one-to-one reservation, a one-to-multiple reservation, or a multiple-to-one reservation” enables different modes of resource reservation for SL-PRS to be implemented depending on application. In contrast, DL-PRS does not require different kinds of reservation since a gNB can dynamically schedule the DL-PRS.
Statement 4. The communication apparatus of Statement 3, wherein the signaling is a 1st stage sidelink control information (SCI) and/or a 2nd stage SCI, and the resource reservation is based on the 1st stage SCI, the 2nd stage SCI, or both 1st stage SCI and 2nd stage SCI.
   The feature “signaling is a 1st stage and/or 2nd stage sidelink control information (SCI), and the resource reservation is based on the 1st stage SCI, the 2nd stage SCI, or both 1st and 2nd stage SCI” enables 1st stage and/or 2nd stage SCI to be used as the signaling to provide parameters for SL-PRS resource reservation.
Statement 5. The communication apparatus of Statement 1, wherein the transmitter is further configured to transmit the SL-PRS within a window, a counter, or a timer.
   Transmission of the SL-PRS within a window, a counter, or a timer enables efficient transmission to minimize power usage as well as manage congestion control.
Statement 6. The communication apparatus of Statement 1, wherein the signaling comprises one or more parameters associated with the SL-PRS, and the transmitter is configured to transmit the SL-PRS based on the one or more parameters.
   The feature “the signaling comprises one or more parameters associated with the SL-PRS” enables flexibility of SL-PRS parameter provisions (besides provision of such parameters via (pre-)configuration, obtained from a gNB, obtained from another SL-UE, or self-generated by the transmitting UE) depending on application.
Statement 7. The communication apparatus of Statement 1, wherein the signaling is a higher layer signaling associated with the communication apparatus.
   Utilizing the UE's own higher layer signaling as the signaling enables the signaling to be independent of other devices if necessary.
Statement 8. The communication apparatus of Statement 1, wherein further comprising a receiver, which in operation, receives the signaling from another communication apparatus, the signaling being a 1st stage sidelink control information (SCI) and/or a 2nd stage SCI, a Physical Downlink Control Channel (PDCCH), or a higher layer signaling associated with the another communication apparatus.
   This feature advantageously enables the origin of the signaling to be flexible depending on application.
Statement 9. A communication apparatus, comprising: a receiver, which in operation, receives a sidelink positioning reference signal (SL-PRS) based on a signaling; and circuitry, which in operation, decodes the SL-PRS.
   As it is not straightforward to reuse existing DL-PRS techniques for SL-PRS transmission (since SL is a UE-to-UE transmission), the feature “receives the SL-PRS based on a signaling” introduces a signaling for reception of SL-PRS to advantageously provide a solution on how SL-PRS can be received by a UE.
Statement 10. The communication apparatus of Statement 9, wherein the receiver is further configured to receive the SL-PRS within a window, a counter, or a timer. Reception of the SL-PRS within a window, a counter, or a timer enables efficient transmission to minimize power usage as well as manage congestion control.
Statement 11. The communication apparatus of Statement 9, wherein the signaling is a higher layer signaling associated with the communication apparatus, or wherein the receiver is further configured to receive the signaling from another communication apparatus, the signaling being a 1st stage sidelink control information (SCI) and/or a 2nd stage SCI, a Physical Downlink Control Channel (PDCCH), or a higher layer signaling associated with the another communication apparatus.
   Utilizing the UE's own higher layer signaling as the signaling enables the signaling to be independent of other devices if necessary. Further, it is also possible for the signaling to be received from another UE, enabling the origin of the signaling to be flexible depending on application.
Statement 12. The communication apparatus of Statement 11, wherein the communication apparatus is a Rel. 16/17 user equipment (UE), the another communication apparatus is a Rel. 18 UE, the 2nd stage SCI is a Rel. 18 2nd stage SCI, and the signaling further comprises a Rel. 18 Physical Sidelink Shared Channel (PSSCH), and the circuitry is further configured to discard the Rel. 18 2nd stage SCI and the Rel. 18 PSSCH when decoding the signaling.
   This feature advantageously enables backward compatibility for Rel. 16/17 UEs when receiving a Rel. 18 based signaling from a Rel. 18 UE.
Statement 13. The communication apparatus of Statement 11, wherein the communication apparatus is a Rel.16/17 user equipment (UE), the another communication apparatus is a Rel. 18 UE, the 2nd stage SCI is a Rel. 16/17 2nd stage SCI and the signaling comprises a Rel. 18 PSSCH, and the circuitry is further configured to skip decoding the Rel. 18 PSSCH when decoding the signaling.
   This feature advantageously enables backward compatibility for Rel. 16/17 UEs when receiving a Rel. 16/17 based signaling from a Rel. 18 UE.
Statement 14. The communication apparatus of Statement 9, wherein the signaling comprises a resource set identifier associated with the SL-PRS, and the receiver is configured to receive the SL-PRS based on a comparison of the resource set identifier with an identifier associated with the communication apparatus.
   The feature “receive the SL-PRS based on a comparison of the resource set identifier with an identifier associated with the communication apparatus” enables SL-PRS resources to be assigned to an appropriate SL-PRS based on an identifier, for improved transmission efficiency of SL-PRS.
Statement 15.A first communication apparatus, comprising: circuitry, which in operation, generates a signaling indicating a request to transmit or receive a sidelink positioning reference signal (SL-PRS); and a transmitter, which in operation, transmits the signaling to a second communication apparatus.
   As it is not straightforward to reuse existing DL-PRS techniques for SL-PRS transmission (since SL is a UE-to-UE transmission), the feature “generates . . . and transmits the signaling . . . ” introduces a signaling for transmission of SL-PRS to advantageously provide a solution on how SL-PRS can be transmitted by a UE.
Statement 16. The first communication apparatus of Statement 15, wherein the signaling indicates one or more communication apparatuses or one or more types of communication apparatus for transmitting the SL-PRS.
   By indicating one or more communication apparatuses or one or more types of communication apparatus for transmitting the SL-PRS in the signaling, broadcast/groupcast of signaling can advantageously be enabled while selectively indicating which communication apparatus to transmit the SL-PRS.
Statement 17. The first communication apparatus of Statement 15, wherein the transmitter is further configured to transmit the signaling as a physical layer (PHY) signaling or a higher layer signaling based on a priority associated with the SL-PRS.
   The feature “transmit the signaling as a physical layer (PHY) signaling or a higher layer signaling based on a priority associated with the SL-PRS” enables transmission mode of signaling to be defined depending on a priority associated with the SL-PRS, so that a more efficient transmission mode may be provided for a higher priority.
Statement 18. The first communication apparatus of Statement 16, wherein the signaling further indicates a time and/or frequency resource for transmitting the SL-PRS.
   By indicating a time and/or frequency resource for SL-PRS transmission, it is possible to implement resource management for the SL-PRS transmission based on the signaling.
Statement 19. The first communication apparatus of Statement 16, wherein the transmitter is further configured to transmit the signaling periodically via a unicast, groupcast or broadcast.
   This feature enables signaling to be transmitted via a unicast, groupcast or broadcast periodically (e.g., from an anchor UE) depending on the application.
Statement 20. A communication method, comprising: generating a sidelink positioning reference signal (SL-PRS); and transmitting the SL-PRS based on a signaling.
   As it is not straightforward to reuse existing DL-PRS techniques for SL-PRS transmission (since SL is a UE-to-UE transmission), the feature “transmitting the SL-PRS based on a signaling” introduces a signaling for transmission of SL-PRS to advantageously provide a solution on how SL-PRS can be transmitted by a UE.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1-20. (canceled)

21. A communication apparatus, comprising:
circuitry, which, in operation, generates a sidelink positioning reference signal (SL-PRS); and
a transmitter, which, in operation, transmits the SL-PRS based on a signaling.

22. The communication apparatus of claim 21, wherein the signaling indicates a periodicity of the SL-PRS, and the transmitter, in operation, transmits the SL-PRS periodically based on the signaling.

23. The communication apparatus of claim 21, wherein the transmitter, in operation, transmits the SL-PRS with a resource reservation, the resource reservation being a one-to-one reservation or a one-to-multiple reservation.

24. The communication apparatus of claim 23, wherein, when the resource reservation is the one-to-multiple reservation, the multiple is configurable.

25. The communication apparatus of claim 23, wherein the signaling is a 1st stage sidelink control information (SCI), and the resource reservation is based on the 1st stage SCI.

26. The communication apparatus of claim 21, wherein the transmitter, in operation, transmits the SL-PRS within a window or a counter.

27. The communication apparatus of claim 21, wherein the signaling comprises one or more parameters associated with the SL-PRS, and the transmitter, in operation, transmits the SL-PRS based on the one or more parameters.

28. The communication apparatus of claim 21, wherein the signaling is a higher layer signaling associated with the communication apparatus.

29. The communication apparatus of claim 21, comprising:
a receiver, which, in operation, receives the signaling from another communication apparatus, the signaling being a 1st stage sidelink control information (SCI), a Physical Downlink Control Channel (PDCCH), or a higher layer signaling associated with the another communication apparatus.

30. The communication apparatus of claim 21, wherein a priority of the SL-PRS is indicated by a physical layer (PHY) signaling or a higher layer signaling.

31. The communication apparatus of claim 30, wherein the priority of the SL-PRS is set from eight values.

32. The communication apparatus of claim 21, wherein the signaling indicates a time resource for transmitting the SL-PRS.

33. The communication apparatus of claim 21, wherein the transmitter, in operation, transmits the signaling periodically via unicast, groupcast or broadcast.

34. The communication apparatus of claim 21, wherein the transmitter, in operation, transmits the signaling via groupcast or broadcast when triggered by another communication apparatus.

35. A communication apparatus, comprising:
a receiver, which, in operation, receives a sidelink positioning reference signal (SL-PRS) based on a signaling; and
circuitry, which, in operation, decodes the SL-PRS.

36. The communication apparatus of claim 35, wherein the receiver, in operation, receives the SL-PRS within a window.

37. The communication apparatus of claim 35, wherein the signaling is a higher layer signaling associated with the communication apparatus, or wherein the receiver, in operation, receives the signaling from another communication apparatus, the signaling being a 1st stage sidelink control information (SCI), a Physical Downlink Control Channel (PDCCH), or a higher layer signaling associated with the another communication apparatus.

38. A communication method, comprising:
generating a sidelink positioning reference signal (SL-PRS); and
transmitting the SL-PRS based on a signaling.
